(19) United States
(12) Patent Application Publication
(10) Pub. No.: US 2013/0146613 A1
(43) Pub. Date: Jun. 13, 2013

(54) SAFETY SYSTEM WITH A TRANSPONDER AND A READING DEVICE OF AN RFID SYSTEM

(71) Applicant: Eduard Balthes, Ingelheim am Rhein (DE)

(72) Inventor: Eduard Balthes, Ingelheim am Rhein (DE)

(21) Appl. No.: 13/701,870

(22) PCT Filed: May 31, 2011
(86) PCT No.: PCT/EP2011/058871

§ 371 Date: Feb. 8, 2013

(30) Foreign Application Priority Data
Jun. 7, 2010 (EP) 10165127.1

(51) Int. Cl. G05B 9/00

(52) U.S. Cl. CPC G05B 9/00
USPC 222/52

(57) ABSTRACT

A safety system comprises a transponder (3) and a reading device (5) of an RFID system, the transponder (3) being associated with a pharmaceutical product (2) and the reading device (5) being associated with an application device (4) for the pharmaceutical product (2) and the application device (4) being usable only after being enabled by the RFID system. The transponder (3) is associated, in an inaccessible manner, with a container (7) filled with the pharmaceutical product (2), which can be inserted in the application device (4).

The invention relates to a safety system comprising a transponder and a reading device of an RFID system, the transponder being associated with a pharmaceutical product and the reading device being associated with an application device for the pharmaceutical product, while the application device can only be used after being enabled by the RFID system.

Pharmaceutical products are packaged in all kinds of preparation forms, for example for spraying an active substance, breathing in an aerosol or absorbing an active substance through the skin. Often, additional application means are required for taking and/or administering medicaments, such as for example an inhaler, a spray, a nebuliser for producing aerosols or the like.

The correct association of a pharmaceutical product that is to be administered to an application device by means of which the pharmaceutical product is applied or taken, is thus of considerable importance to prevent the administration of incorrect doses of pharmaceutical products, medicaments or active substances or to prevent the administration of an entirely wrong medicament.

For this purpose it is known, inter alia, to configure certain application devices, particularly inhalers that work with a cartridge, a bottle or other container filled with a pharmaceutical product, so that for example only a specific shape of package can be inserted or latched in a receiving opening. Thus, pharmaceutical products made by a different manufacturer cannot be used with an application device of this kind. Moreover, colour coding may be provided on drug packs and the associated application devices, warning notices may be provided on packages and on the in-pack leaflets, or the use of particularly critical pharmaceutical products is reserved for trained medical staff only.

In addition, safety systems for preventing the incorrect use of a pharmaceutical product have been proposed, in which a transponder of an RFID system is associated with a pharmaceutical product. RFID (“radio frequency identification device”) systems are systems that consist of a usually passive transponder and an associated reading device, for identifying and/or locating objects or people using electromagnetic waves. The transponder is provided for example on secondary packaging such as a cardboard carton for holding a medicament contained in primary packaging and may be brought into the detection range of a reading device on an application device. The reading device automatically detects that an authorised transponder which has the correct coding for this pharmaceutical product is within the detection range. A release signal can then be emitted by the reading device, to enable the use of the application device in conjunction with the pharmaceutical product.

However, the possibility of tampering cannot be ruled out, whereby the pharmaceutical product packaged in a primary packaging such as a blister film or cartridge may be separated from the secondary packaging comprising the transponder and, for example, a counterfeit pharmaceutical product is placed in the secondary packaging. Also, the user may take different pharmaceutical products out of different packs and put them back in the wrong packs. There is also the possibility of product counterfeiting, if it is possible to separate the transponder from the pharmaceutical product or its packaging and associate it with a different pharmaceutical product, for example a counterfeit product.

The invention is based on the problem of providing a safety system of the type described at the beginning with which tamper-proofing and particularly protecting a patient from a counterfeit pharmaceutical product is increased and at the same time incorrect application of the pharmaceutical product is effectively prevented.

According to the invention the problem is solved in that the transponder is associated in an inaccessible manner with a container filled with the pharmaceutical product, which container can be inserted in the application device.

In a safety system thus configured the transponder of an RFID system known in the art is housed for example inside the container or a wall of the container for the pharmaceutical product. In particular, it is important that after being filled with the pharmaceutical product the container is sealed at the factory and the transponder is thereby housed in an inaccessible manner.

This means that, for example, when the pharmaceutical product is packaged in a blister pack, when inhalable powders or inhalable liquids are transferred into a single- or multi-dose inhaler, when a pharmaceutical product is placed in a container, particularly in the form of a capsule or cartridge, in a dosing pen, when a medicament is prepared for use in a nebuliser or an infusion device is placed in the container, for example a primary package, the transponder is also placed in the corresponding container or is embedded in material used to produce the container.

Naturally, the transponder is provided with corresponding coding for the accurate designation and/or administration of the pharmaceutical product, in order that an application device, of any desired configuration, can only be enabled by means of the reading device when the correct pharmaceutical product is supplied to the application device. It is also envisaged within the scope of the invention that the reading device is associated in an inaccessible manner with the container and the transponder is arranged on the application device. The transponder may also be both a passive transponder that is activated or read by electromagnetic waves from the reading device, or an active transponder that automatically emits electromagnetic waves and is equipped for this purpose with an energy source such as a battery. In the same way, the transponder may also be incorporated in the material of the container. Examples of materials used for a container may include plastic-metal composite materials or sandwich systems, between the several layers of which a transponder may be incorporated. Suitable materials for elastic or rigid containers may be produced to the desired wall thickness by the skilled man.

The advantage of the invention is that it is only possible to manipulate the transponder inside the container when the latter is opened or destroyed, while the container is preferably designed so that any opening or manipulation is immediately apparent to a user and is irreversible, thus enabling the user or patient to draw inferences as to a counterfeit pharmaceutical product or a container that is no longer in its original state.

Specifically, the container comprises an inner container, particularly an elastic film container, for the pharmaceutical product and an outer container, particularly a cartridge, that is fixedly attached to the inner container, the transponder being arranged in an intermediate space provided between the inner container and the outer container. In the simplest case the transponder is loosely stowed in the intermediate space of the double-walled container before the latter is sealed up with the pharmaceutical product contained therein. Of course, a double-walled pouch for holding an active substance formulation is also conceivable.

Expediently, the transponder is attached to the outer wall of the inner container or the inner wall of the outer container, preferably in non-detachable manner. For example the transponder is glued in place. The positioning of the transponder on the container facilitates the transmission of signals between the transponder and the reading device when the container is located in the application device for the proper administration of the pharmaceutical product.

In an alternative embodiment, the container comprises a laminate between the layers of which the transponder is arranged. The laminate expediently comprises a plurality of layers of at least one metal foil, particularly aluminium foil, and at least one plastic film, the metal foil forming an exterior of the container, particularly of a blister pack or a pouch.

Preferably, a safety system of this kind is used in primary packages of a medicament that contain at least partly metallic components. These are for example blister packs with an aluminium foil or aluminium composite foil or containers with a metallic lid or seal.

Because of the electromagnetic waves used in an RFID system a metallic or metal-containing container would, as expected, interfere with or shield the penetration of the electromagnetic waves from the reading device from the outside inwards to the transponder. However, if a low-frequency RFID system is used, the low-frequency long-wave electromagnetic waves are able to pass through a wall of such a container, at least in attenuated form, and the coding of the transponder can be read. This has proved effective in particular for frequencies of less than 500 kHz, preferably less than 30 kHz. Such frequencies may also penetrate metal layers or foils with a wall thickness of more than 0.3 to 0.5 mm, corresponding to the foil materials conventionally used in pharmaceutical packaging.

Preferably, an expiry date or a best-before date for the pharmaceutical product can be stored in the coding in the transponder, so that after the date specified therein it is impossible to use the pharmaceutical product which is no longer medically safe at that stage, as the application device can no longer be enabled.

Similarly, the safety system may be individualised to make it childproof. For this purpose, an authorised user may be allocated a reading device in the form of a releasing unit, for example in the form of an arm band or a decorative chain, an SOS capsule or, in some cases, an implant. Thus, different medical products can only be made accessible when the patient has a corresponding enabling unit. The safety system may be designed such that on the one hand the signal from the transponder is read by the reading device on the application device and on the other hand a signal from the releasing unit is requested and verified. Only if both signals are permissible can the medicament be used. The same applies for example to the use of medicaments in geriatric wards, for allocating certain medicaments and/or dosages to certain patients.

It is also possible to assign a moisture detector to the medicament and to the transponder, inside the container, particularly in the intermediate space thereof. The moisture detector responds in the event of moisture getting in, with the consequent risk of an adverse effect on the pharmaceutical product or on its usability or suitability for administration, and is operatively connected to the transponder, so that in the event of unwanted moisture occurring the application device is not enabled.

Finally, the date and/or time can be read off using the transponder, to allow the release of specific pharmaceutical products only at certain times of the day, if this is medically advised.

The invention is hereinafter explained in more detail by means of two embodiments by way of example, with reference to the drawings, wherein:

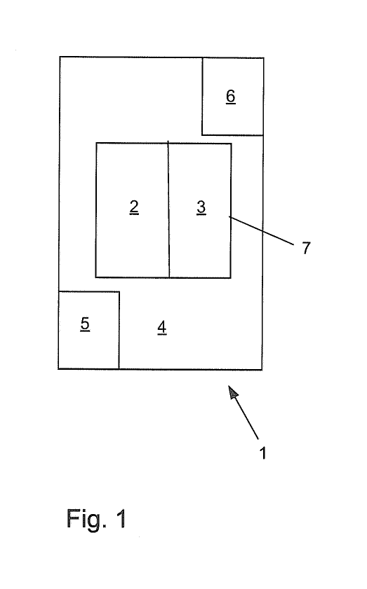

FIG. 1 is a schematic view of a safety system according to the invention and

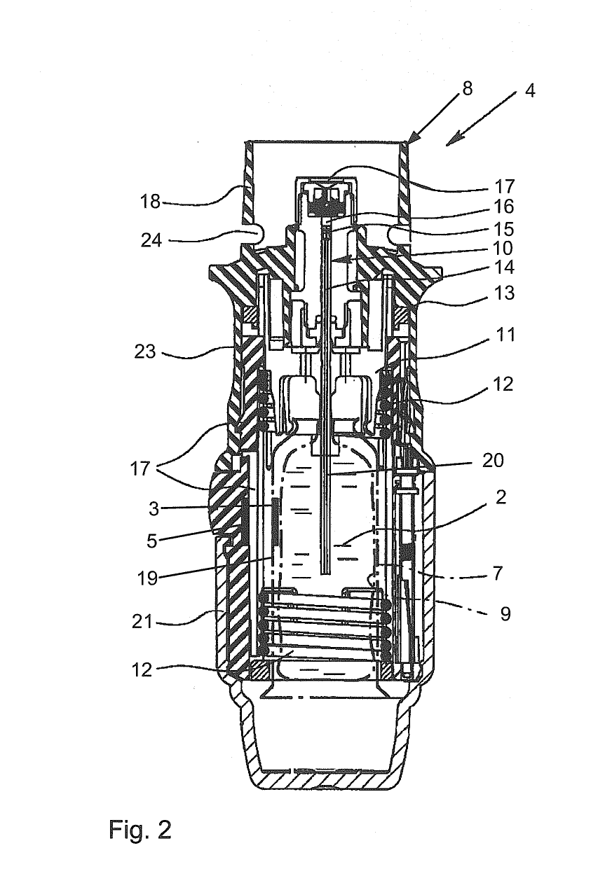

FIG. 2 is a sectional view of the safety system according to FIG. 1 comprising a nebuliser.

The safety system 1 is used to prevent the improper use or consumption of an unidentified pharmaceutical product 2 by means of an application device 4. For this purpose, a transponder 3, preferably in the form of a corresponding magnetic strip, is associated, in an inaccessible manner, with a container 7 for the pharmaceutical product 2. Moreover, a reading device 5 is associated with the application device 4. For the application or taking of the pharmaceutical product 2 the container 7 with the pharmaceutical product 2 has to cooperate with the application device 4, for example a liquid medicament contained in portions in a bottle has to cooperate with an injection device.

The reading device 5 detects whether the transponder 3 is provided with a correct code for the pharmaceutical product 2, the application device 4 being capable of cooperating with different pharmaceutical products 2 with different transponders 3. If the transponder 3 associated with the container 7 and hence with the pharmaceutical product 2 is evaluated by the reading device 5 as being correct, the application device 4 is mechanically and/or electronically enabled, to allow the pharmaceutical product 2 to be taken or administered. At the same time a corresponding signal of confirmation or refusal, in the event of the pharmaceutical product 2 or container 7 being wrong, can be emitted by indicator means 6, for example a speaker and/or an LED.

The container 7 comprises metal components. It has been found that, particularly in low-frequency RFID systems with frequencies preferably less than or equal to 500 kHz, preferably less than or equal to 30 kHz, the electromagnetic waves emitted by the reading device 5 are able to penetrate the metal or metal-containing container 7 and cooperate with the transponder 3 in order to enable the application device 4. Normally, a container 7 of this kind shields the electromagnetic waves of the reading device 5, but with a suitable choice of frequency and a suitable metallic material for the container 7, for example a metal-plastics sandwich construction with a thickness of 0.3 to 0.5 mm, it will pass through the latter. A magnetic strip or a transponder chip may be incorporated between several layers of the sandwich construction.

The application device 4 embodied as a nebuliser 8 serves to nebulise the liquid pharmaceutical product 2 and is configured as a portable inhaler that operates without propellant gas. When the medicament 2, preferably a liquid, is nebulised, an aerosol is formed that can be breathed in by a user.

The nebuliser 8 comprises the replaceable container 7 with the pharmaceutical product 2, while the double-walled container 7 has an essentially cylindrical configuration and can be inserted in the opened nebuliser 8 from below. In a rigid outer container 19 of the container 7, which is made of metal, is an inner container 9 that holds the pharmaceutical product 2 and is embodied as an elastic film container. The transponder 3, which cooperates with the reading device 5 in the nebuliser 8, is located in the intermediate space that is located between the outer container 19 and the inner container 9, which is inaccessible after the container 7 filled with the pharmaceutical product 2 has been sealed.

In order to nebulise the pharmaceutical product 2 in a predefined, adjustable quantity, the nebuliser 8 comprises a pressure generator 10 comprising a piston 20, with a holder 11 for the container 7, a drive spring 12 with a release button 13 that is to be actuated manually to release it, a conveying tube 14 with a non-return valve 15 inserted therein, a pressure chamber 16 and a nozzle 17 associated with a mouthpiece 18.

When the drive spring 12 is axially tensioned by rotating a lower housing part 21 with an inner part 22 releasably attached thereto, relative to an upper housing part 23 formed on the mouthpiece 18, the holder 11 with the container 7 and the conveying tube 14 is moved downwards and fluid is aspirated out of the container 7 through the non-return valve 15 into the pressure chamber 16 associated with the piston 20 of the pressure generator 10. During the subsequent abrupt relaxation of the drive spring 17 caused by the actuation of the release button 13, the pharmaceutical product 2 in the pressure chamber 16 is put under pressure by the drive spring 12 moving the conveying tube 14 upwards and is expelled through the nozzle 17, whereupon nebulisation takes place. The nebulisation results, for example, in particles in the μm size range, preferably particles about 20 μm in size, which form a mist or jet of aerosol. A user can inhale the aerosol, while supply air can be aspirated through supply air openings 24 in the mouthpiece 18.

If the reading device 5 cannot receive an authorised signal from the transponder 3, the release button 13 is forcibly locked by a device (not shown) and no pharmaceutical product 2 can be nebulised.

1. A safety system having a transponder (3) and a reading device (5) of an RFID system, the transponder (3) being associated with a pharmaceutical product (2) and the reading device (5) being associated with an application device (4) for the pharmaceutical product (2), and the application device (4) being usable only after being enabled by the RFID system, characterised in that the transponder (3) is associated, in an inaccessible manner, with a container (7) filled with the pharmaceutical product (2), which container can be inserted in the application device (4).

2. The safety system according to claim 1, characterised in that the container (7) comprises an inner container (9), more particularly an elastic foil container, for the pharmaceutical product (2) and an outer container (19), particularly a cartridge, fixedly attached to the inner container (9), the transponder (3) being arranged in an intermediate space located between the inner container (9) and the outer container (19).

3. The safety system according to claim 2, characterised in that the transponder (3) is attached to the outer wall of the inner container (9) or to the inner wall of the outer container (19), preferably in non-detachable manner.

4. The safety system according to claim 1, characterised in that the container (7) comprises a laminate, between the layers of which the transponder (3) is arranged.

5. The safety system according to claim 4, characterised in that the laminate comprises several layers of at least one metal foil, particularly aluminium foil, and at least one plastics film, the metal foil forming an exterior of the container (7), particularly of a blister pack or a pouch.

6. The safety system according to claim 1, characterised in that the container (7) comprises at least one metallic layer, particularly having a wall thickness of between 0.3 and 0.5 mm.

7. The safety system according to claim 1, characterised in that the RFID system is a low frequency RFID system, preferably with a frequency of 500 kHz, particularly with a frequency of 30 kHz.

8. The safety system according to claim 1, characterised in that an expiry date of the pharmaceutical product (2) is stored in the transponder (3).

9. The safety system according to claim 1, characterised in that the safety system (1) can be individualised, and in particular can be childproofed by means of an additional releasing unit.

10. The safety system according to claim 1, characterised in that a moisture detector is associated with the pharmaceutical product (2) and the transponder (3).

11. The safety system according to claim 1, characterised in that the dates and times of use of the pharmaceutical product (2) are stored in the transponder (3).
